(19) United States
(12) Patent Application Publication
(10) Pub. No.: US 2026/0081298 A1
(43) Pub. Date: Mar. 19, 2026

(54) ELECTROCHEMICAL DEVICE PROVIDED WITH A SAFETY ARRANGEMENT FOR A POUCH CELL

(71) Applicant: ABB Schweiz AG, Baden (CH)

(72) Inventors: Minglong He, Rheinfelden (CH); Gabriel SCHULER, Arth (CH); Helge Kolstad, Oslo (NO)

(21) Appl. No.: 19/398,760

(22) Filed: Nov. 24, 2025

Related U.S. Application Data
(63) Continuation of application No. PCT/EP2023/063874, filed on May 24, 2023.

(51) Int. Cl. H01M 50/342; H01M 10/647; H01M 10/658; H01M 50/105; H01M 50/358

(52) U.S. Cl. CPC H01M 50/3425; H01M 10/647; H01M 10/658; H01M 50/105; H01M 50/358

(57) ABSTRACT

An electrochemical device comprises device comprising at least one pouch cell and a safety arrangement is described. The safety arrangement comprises a holding structure and at least one pouch piercing element. The at least one pouch piercing element is held adjacent to a corresponding pouch cell by the holding structure with a piercing end facing the corresponding pouch cell. Each flexible pouch cell is attached to the holding structure and is expandable in at least one direction, and one of the directions is towards the corresponding piercing element so that the piercing element pierces the pouch cell at the piercing end.

### CROSS REFERENCE TO RELATED APPLICATIONS

The present application is a continuation of, and claims priority to, International Patent Application No. PCT/EP2023/063874, filed on May 24, 2023, and titled “ELECTROCHEMICAL DEVICE PROVIDED WITH A SAFETY ARRANGEMENT FOR A POUCH CELL”, which is hereby incorporated by reference in its entirety.

### TECHNICAL FIELD

The present disclosure relates to an electrochemical device that comprises at least one pouch cell and a safety arrangement for the pouch cell.

### BACKGROUND

Having dominated as the power sources for consumer electronics, Li-ion batteries are advancing into the field of transportation such as electric vehicle (EV) and stationary energy storage sector such as grid support and datacenter uninterruptible power supply (UPS).

Several technology trends have been seen in battery development. Some such trends are: 1. Battery using cell chemistry without deficient or problematic elements such as cobalt. 2. Cell either with a big cell size or high energy chemistry, 3. High-power battery allowing fast charging and discharging.

Typically, those high energy and high power performances are achieved at a cost of increased safety risks.

One such safety risk that may occur is thermal runaway.

Thermal runaway is defined as the incident when a cell increases its temperature through self-heating in an uncontrollable manner, which causes gassing within the cell. The thermal runaway could be induced by different abuse conditions. Certain abuse conditions such as overcharging, and overheating make the gassing worse or even result in disastrous accidents. In overcharging, the gassing occurs mainly through the electrochemical oxidation of electrolyte solvents on the cathode with the Li+ ions from the electrolyte being reduced into metallic Li on the anode. In overheating, the gassing takes place through not only the redox decomposition but also the chemical decomposition of the electrolyte solvents on both the anode and cathode besides the vapor expansion of volatile electrolyte solvents. The generated gasses containing CO, H2, CxHy species are flammable.

In order to address safety issues, several fail-safe designs such as safety vents and thermal fuses have been implemented in commercial cells.

The pouch cell is attractive to use in batteries due to its simplistic design and low amount of additional parts and mass.

However, the simplistic pouch design shifts some features to the upper integration levels, for example, module integration or pack integration. As an example, there is no venting design in commercial pouch type cells. The abuse or severe ageing generated gasses will accumulate inside the pouch bag and result in a swollen cell like a balloon. The swollen cells therefore lead to the deformation of battery module.

There is a need for new safety features in a pouch cell.

One solution described in KR101452028 employs a venting assembly comprising an acicular body placed between two pouch cells. When one of the pouch cells expands it is pressed against the venting assembly, which in turn causes the acicular body to protrude and make a hole in the pouch cell.

However, there is still room for improvement within the field, especially with regard to the control of the piercing activity.

### BRIEF DESCRIPTION

One object of the present disclosure is to provide an improved electrochemical device comprising a pouch cell, where the improvement is especially obtained with regard to the control of a piercing activity being performed when the pouch cell is subjected to thermal runaway. The objects of the present disclosure are achieved by the subject-matter of the independent claim. Further exemplary embodiments are evident from the dependent claims and the following description. The embodiments and features, if any, described in this specification that do not fall under the scope of the independent claim are to be interpreted as examples useful for understanding various embodiments of the present disclosure.

According to an aspect of the present disclosure, an electrochemical device comprising at least one pouch cell and a safety arrangement comprising a holding structure and at least one pouch piercing element is provided. The at least one pouch piercing element is held adjacent to a corresponding pouch cell by the holding structure with a piercing end facing the corresponding pouch cell, and each pouch cell is attached to the holding structure and is expandable in at least one direction, and one of the directions is towards the corresponding piercing element so that the piercing element pierces the pouch cell at the piercing end.

According to another aspect of the present disclosure, the holding structure may be a holding structure that holds piercing elements of the safety arrangement.

According to another aspect of the present disclosure, the holding structure comprises at least one element applying pressure on the at least one pouch cell for limiting the possible directions of expansion.

According to another aspect of the present disclosure, a pouch cell is enclosed in a hemming structure. In this case, the holding structure may surround the pouch cell and may additionally comprise a first and second piece, each having a first edge, where the first edge of the first piece is folded around the first edge of the second piece or vice versa for forming a first mechanical connection. In this case the piercing element may be placed between the pouch cell and the holding structure adjacent the mechanical connection.

According to another aspect of the present disclosure, the first and second pieces may be metallic. Alternatively, they may be ceramic or made of polymer materials.

According to another aspect of the present disclosure, when a hemming structure is used, the pouch cell may additionally be surrounded by thermal insulation or thermosealing material, which thermal insulation or thermosealing material may have a cavity adjacent the piercing element and in which the pouch cell can expand.

According to another aspect of the present disclosure, the electrochemical device comprises a first fluid channel for transporting of fluid to or from the pouch cell and possibly also to or from the piercing element.

According to another aspect of the present disclosure, the transporting of fluid from the pouch cell may comprise the venting of gases that are generated in the pouch cell due to thermal runaway. The transporting of fluid to the pouch cell may comprise the transporting of cooling fluid and/or fire retardants to the pouch cell.

According to another aspect of the present disclosure, the first fluid channel may additionally be a part of the holding structure.

According to another aspect of the present disclosure, a second fluid channel is provided in the piercing element and stretches between a first opening provided at the piercing end and a second opening at another end of the piercing element, where the second fluid channel allows fluid to flow between the exterior and interior of the pouch cell.

According to another aspect of the present disclosure, the second opening of the piercing element may also be an opening in the wall of the first fluid channel.

According to another aspect of the present disclosure, the piercing element may additionally or instead be attached to the holding structure via a first resilient element.

According to another aspect of the present disclosure, the pouch cell is attached to the piercing element or the holding structure via a second resilient element.

According to another aspect of the present disclosure, the electrochemical device may further comprise a thermally sensitive film between the pouch cell and the holding structure.

According to another aspect of the present disclosure, when the holding structure comprises the first fluid channel, the first resilient element is placed between the pouch cell and an interior wall of the first fluid channel furthest away from the pouch cell. In this case the expansion of the pouch cell may cause the piercing element to move from a first to a second position, where the second opening is separated from the first fluid channel in the first position and opens into the first fluid channel in the second position.

According to another aspect of the present disclosure, the expansion of the pouch cell causes the piercing element to move in the direction of expansion so that the second opening enters the first fluid channel. The piercing element may in this case be placed in and moved in a channel connection leading into the first fluid channel.

According to another aspect of the present disclosure, the thermally sensitive film may be placed in the second fluid channel of the piercing element so that the pouch cell ruptures the thermally sensitive film when expanding along the direction of expansion.

According to another aspect of the present disclosure, the holding structure may be a tape fastened to the pouch cell.

According to another aspect of the present disclosure, the thermally sensitive film may be provided between the piercing end of the piercing element and the pouch cell for being softened by heated emanating from the pouch cell and release the piercing element to move towards the pouch cell.

According to another aspect of the present disclosure, there may be more than one pouch cell in the electrochemical device. In this case the holding structure may comprise a piercing element for each pouch cell and the first fluid channel may pass by each piercing element.

According to another aspect of the present disclosure, the pouch cells may additionally be provided in at least one stack, where each layer of the stack comprises at least one pouch cell. In this case the holding structure may comprise a number of support plates, one for two layers of the stack, where an edge of a support plate is folded over first edges of the pouch cells of a corresponding first stack layer or vice versa, and the first fluid channel is provided between these overlapping edges.

According to another aspect of the present disclosure, another edge of the support plate is folded over second edges of the pouch cells of a corresponding second stack layer or vice versa.

### BRIEF DESCRIPTION OF DRAWINGS

The subject matter of the present disclosure will be explained in more detail in the following text with reference to exemplary embodiments which are illustrated in the attached drawings.

FIG. 1 shows a perspective view of a first embodiment of an electrochemical device comprising a housing in which a number of pouch cells are stacked upon each other according to an embodiment of the present disclosure.

FIG. 2 shows a side view of the first embodiment of the electrochemical device comprising a holding structure with a first fluid channel and a number of piercing elements of a first type comprising a second fluid channel according to an embodiment of the present disclosure.

FIG. 3 shows a side view of the first embodiment of the electrochemical device where a first pouch cell experiences thermal runaway and gets pierced by a corresponding piercing element according to an embodiment of the present disclosure.

FIG. 4 shows a side view of the first type of piercing element according to an embodiment of the present disclosure.

FIG. 5 shows a perspective view of a second embodiment of an electrochemical device comprising a housing in which pouch cells are stacked in a number of stack layers separated by support plates according to an embodiment of the present disclosure.

FIG. 6 shows a view from above of two pouch cells of a first layer of the stack provided on a support plate, a first edge of which is folded over first edges of pouch cells of the first layer according to an embodiment of the present disclosure.

FIG. 7 shows a side view of the first and a second layer of the stack inside the housing, with the first edge of the first support plate being folded over the first edges of the pouch cells of the first layer, with a second edge of the first support plate being folded over second edges of the pouch cells of the second layer and with piercing elements of a second type provided at the folded edges according to an embodiment of the present disclosure.

FIG. 8 shows the same side view as in FIG. 7, where a pouch cell in the second layer experiences thermal runaway and gets pierced by a corresponding piercing element according to an embodiment of the present disclosure.

FIG. 9 shows a view from above of a third embodiment of an electrochemical device comprising a pouch cell without piercing element and where a corner of the electrochemical device is shown in more detail according to an embodiment of the present disclosure.

FIG. 10A shows a cross-sectional view of the corner of the electrochemical device including a third type of piercing element according to an embodiment of the present disclosure.

FIG. 10B shows a view from above of the corner with the piercing element according to an embodiment of the present disclosure.

FIG. 11 shows a side view of a variation of the second embodiment of the electrochemical device, where the first support plate covers the whole of the top of the first layer and the whole of the bottom of the second layer of pouch cells according to an embodiment of the present disclosure.

FIG. 12 shows a perspective view of a pouch cell with a cooling plate comprising a cooling channel according to an embodiment of the present disclosure.

FIG. 13 shows a side view of the pouch cell with the cooling channel according to an embodiment of the present disclosure.

FIG. 14 shows a side view of the pouch cell with cooling channel, when the pouch cell experiences thermal runaway and gets pierced by a corresponding piercing element that is a variation of the first type according to an embodiment of the present disclosure.

FIG. 15 shows a side view of a fourth type of piercing element according to an embodiment of the present disclosure.

FIG. 16 shows a side view of the fourth type of piercing element being used together with a pouch cell and a first fluid channel according to an embodiment of the present disclosure.

FIG. 17 shows a side view of the fourth type of piercing element, pouch cell and first fluid channel, when the pouch cell experiences thermal runaway and gets pierced by the piercing element according to an embodiment of the present disclosure.

FIG. 18 shows a perspective view of another embodiment of the electrochemical device, where a holding structure of the piercing element is provided as a venting tape attached to a pouch cell according to an embodiment of the present disclosure.

FIG. 19 shows a view from above of the pouch cell with the venting tape according to an embodiment of the present disclosure.

FIG. 20 shows a view from above of a variation of pouch cell with venting tape comprising a thermally sensitive film according to an embodiment of the present disclosure.

FIG. 21 shows a view from above of the variation of pouch cell with venting tape comprising a thermally sensitive film, when the pouch cell experiences thermal runaway and gets pierced by the piercing element according to an embodiment of the present disclosure.

FIG. 22 shows a perspective view of a housing comprising two pouch cells and in which cooling fluid is provided via a cooling fluid inlet/outlet according to an embodiment of the present disclosure.

FIG. 23 shows a perspective view of a variation of the housing comprising two pouch cells according to an embodiment of the present disclosure.

FIG. 24 shows a perspective view of another variation of the housing comprising four pouch cells according to an embodiment of the present disclosure.

FIG. 25 shows a perspective view of yet another variation of the housing comprising eight pouch cells according to an embodiment of the present disclosure.

FIG. 26 shows a perspective view of an embodiment of an electrochemical device comprising a number of housings, the inlet/outlets of which are interconnected with cooling fluid tubes according to an embodiment of the present disclosure.

The reference symbols used in the drawings, and their meanings, are listed in summary form in the list of reference symbols. In principle, identical parts are provided with the same reference symbols in the figures.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

The present disclosure concerns an electrochemical device, such as a battery or supercapacitor, comprising at least one pouch cell and a holding structure holding at least one piercing element.

Aspects of the present disclosure present solutions to handle thermal runaway in an electrochemical device comprising a pouch cell, which pouch cell may be an electrochemical cell such as a battery or supercapacitor.

A pouch cell is a cell, the pouch or bag of which is flexible. The pouch may comprise a metallic layer and two insulating layers, where the metallic layer is sandwiched between the two insulating layers.

The metallic layer may be made of, for example, aluminum and the electrically insulating layers may for instance be polymers or ceramic (cold gas spray) which are fixed to the metallic layer by bonding or lamination.

During operation of a pouch cell it is possible that thermal runaway occurs in the cell. This condition is severe and may lead to the pouch cell exploding if nothing is done.

Aspects of the present disclosure are concerned with the handling of thermal runaway in an electrochemical device comprising at least one pouch cell. Thermal runaway is handled through the employment of a safety arrangement comprising a holding structure to which at least one pouch cell is connected and which holding structure comprises a piercing element for each such pouch cell. How such an electrochemical device can be realized will in the following be described in some more detail.

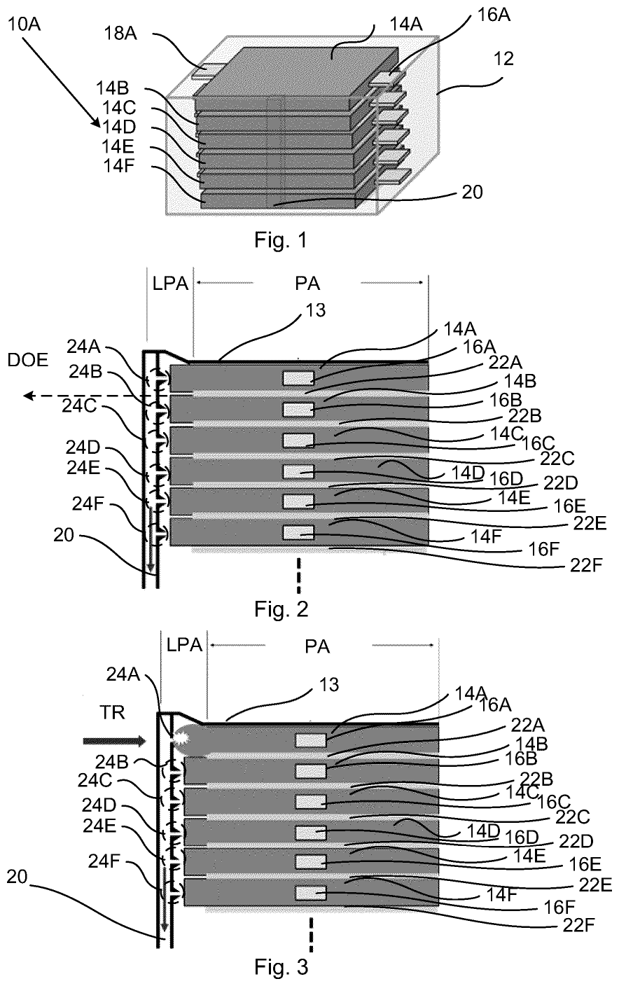

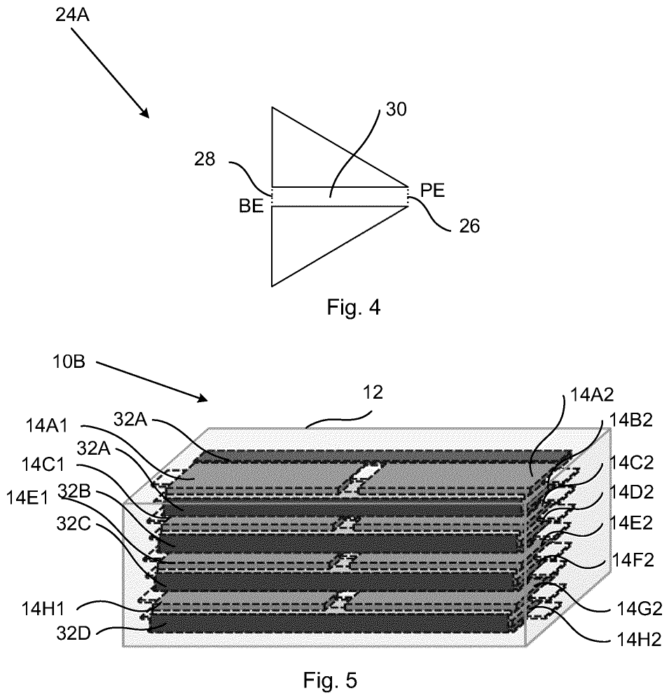

A first embodiment of an electrochemical device will now be described with reference being made to FIG. 1-4, where FIG. 1 shows a perspective view of an electrochemical device comprising a housing in which a number of pouch cells are stacked upon each other, FIG. 2 shows a side view of the electrochemical device comprising a safety arrangement comprising a holding structure with a first fluid channel and a number of piercing elements of a first type, each comprising a second fluid channel, FIG. 3 shows a side view of the electrochemical device where a first pouch cell experiences thermal and gets pierced by a corresponding first piercing element and FIG. 4 schematically shows the first type of piercing element. The holding structure is a structure for holding piercing elements of the safety arrangement.

One purpose of the fluid channels is to be used as vent channels that allows the evacuation of gases generated inside the pouch cells. As can be seen later the fluid channel can also be used to inject fire extinguishing liquids/agents and supply cooling fluid into the pouch cells.

Each pouch cell has a first electrical terminal 16A and a second electrical terminal 18A, which may be anode or cathode terminals. In the figures, the first and second electrical terminals 16A, 18A of the first pouch cell 14A are shown, but only the first electrical terminals 16B-16F of the other pouch cells 14B-14F.

FIG. 1-3 thus outline a first embodiment of an electrochemical device 10A comprising a housing 12 enclosing a number of pouch cells 14A-14F and a number of piercing elements 24A-24F. As an example, there is a first pouch cell 14A, a second pouch cell 14B, a third pouch cell 14C, a fourth pouch cell 14D, a fifth pouch cell 14E and a sixth pouch cell 14F. The pouch cells are provided in a stack, where a pressure plate of a holding structure 13 together with a number of thermal insulating plates 22A, 22B, 22C, 22D, 22E and 22F apply pressure in a pressurized area PA in at least one direction, here in a vertical direction. The pressure plate is here an element applying pressure on the pouch cells for limiting the possible directions of expansion of the pouch cells. There is here a first pressure plate on a top side of the first pouch cell 14A, a first insulating plate 22A between the first and the second pouch cell 14A, 14B, a second insulating plate 22B between the second and third pouch cell 14B, 14C, a third insulating plate 22c between the third and the fourth pouch cell 14C, 14D, a fourth insulating plate 22D between the fourth and the fifth pouch cell 14D, 14E, a fifth insulating plate 22E between the fifth and the sixth pouch cell 14E, 14F as well as a sixth insulating plate on a bottom side of the pouch cell 14F.

The holding structure 13 is in this case also a module frame for the pouch cells.

As can be seen in FIG. 1-3, the holding structure 13 also comprises a first fluid channel 20, which first fluid channel is connected to the pressure plate. The first fluid channel 20 is provided for transporting of fluid to or from the pouch cells 14A, 14B, 14C, 14D, 14E, 14F and the piercing elements 24A, 24B, 24C, 24D, 24E, 24F. In the present example the first fluid channel 20 is a vertically oriented vent channel for venting the pouch cells 14A, 14B, 14C, 14D, 14E, 14F, while the pressure plate is horizontally oriented. A part of the first pouch cell 14A that faces the first fluid channel 20 lacks contact with the pressure plate and thereby the pressure applied on this part of the first pouch cell 14A and corresponding parts of the pouch cells 14B-14H below it is lower than the pressure in the pressurized area PA. This area of lower pressure is thereby a low pressure area LPA.

In the present embodiment there is more than one pouch cell in the electrochemical device. In this case the holding structure comprises a piercing element for each pouch cell. It can also be seen that the first fluid channel passes by each piercing element. Furthermore, the pouch cells are additionally provided in at least one stack and in this case in one stack comprising a number of layers, where each layer comprises one pouch cell.

The holding structure 13 is thus a holding structure that holds a number of piercing elements, one for each pouch cell. There is thus a first piercing element 24A for the first pouch cell 14A, a second piercing element 24B for the second pouch cell 14B, a third piercing element 24C for the third pouch cell 14C, a fourth piercing element 24D for the fourth pouch cell 14d, a fifth piercing element 24D for the fifth pouch cell 14A and a sixth piercing element 24F for the sixth pouch cell 14F.

In this first embodiment of the electrochemical device 10A the piercing elements used are of a first type.

The realization of the first piercing element 24A according to this first type is schematically shown in FIG. 4. The piercing element 24A has a first piercing end PE and a second bottom end BE. There is also a second fluid channel 30 in the piercing element 24A stretching between a first opening 26 provided at the piercing end PE and a second opening 28 at another end of the piercing element, which other end in this case is the bottom end BE. The piercing element may be shaped as a hollow truncated cone. It may also be considered to be a cylinder with even inner diameter and having an outer diameter that increases from the piercing end PE towards the base end. It can also be seen as being shaped as a nail or a pin, where a hole is provided in a pin end. The piercing end may be sharp and capable of piercing a corresponding pouch cell. Through the provision of the second channel 30, fluid may flow between the exterior and interior of the pouch cell. As can be seen in FIGS. 2 and 3, the second openings 28 of the piercing elements 24A, 24B, 24C, 24D, 24E, 24F are also openings in a wall of the first fluid channel.

As can be seen in FIGS. 2 and 3, the piercing elements 24A, 24B, 24C, 24D, 24E, 24F are being held adjacent corresponding pouch cells 14A, 14B, 14C, 14D, 14E, 14F by the holding structure with a piercing end PE facing the corresponding pouch cell. It can also be seen that the piercing elements are provided at a distance from the corresponding pouch cells. In the present example they are horizontally displaced from the corresponding pouch cells. The pouch cells are being expandable in at least one direction, where one of the directions is towards the corresponding piercing element The above-mentioned displacement has been selected to correspond to a certain degree of expansion of the corresponding pouch cell during thermal runway TR. In the first embodiment the piercing elements are also fixedly attached to the holding structure 13. More particularly, it can be seen that the second opening 28 of each piercing element 24A-24F is an opening in an inner wall of the first fluid channel 20. Thereby each second fluid channel 30 is in fluidic communication with the first fluid channel 20.

When a pouch cell experiences thermal runaway TR, gas is generated inside the pouch cell, which causes the pouch cell to expand. Due to the pouch cells being sandwiched between the pressure plate and the insulating plates, the expansion can only occur in the horizonal direction. It is additionally possible that the housing 12 limits the expansion at the end opposite of the first fluid channel 20. Thereby the pouch cells can only expand towards the first fluid channel 20.

FIG. 3 schematically shows this case for the first pouch cell 14A. The first pouch cell 14A expands in a direction towards the first fluid channel 20 due to thermal runaway TR. It can additionally be seen that that the first pouch cell 14A expands so much that it hits the first piercing element 24A, which thereby pierces it. Thereby the gasses inside the pouch cell 14A are released via the second fluid channel 30 into the first fluid channel 20 and are then lead away from the pouch cells, for instance out from the housing 12.

It can in this way be seen that an explosion is avoided. The realization is additionally simple in that no moving parts are used, which simplifies construction and the reliability of the electrochemical device. There is also good control of the piercing activity. The use of a holding structure to which at least the first pouch cell is connected additionally provides control of the expansion of the pouch cells. The use of a fixed location of the piercing elements can also provide a precise selection of which part of a pouch cell is to be pierced in case of thermal runaway, while the use of the second fluid channel can be used to control the flow of gas out of a pierced pouch cell.

The electrochemical device according to the first embodiment can also be described in the following way.

Pouch cells 14A-14F are piled together, and a thermal isolation layer 22A-22E is located between two pouch cells on a large surface side, in order to avoid thermal propagation. A piercing element or nail part 24A-24F is placed towards the side of the pouch or expected vent location. The nail part has a sharp edge and hollow structure inside, one example-with a volcano shape as shown in FIGS. 2, 3, and 4. The module frame 13 is designed with pressurized area PA and low-pressure area LPA. The low-pressure area LPA is the region of the cell side facing the nail parts 24A-24F. During thermal runaway, the abused cell 14A has a fast pressure build-up inside. The gas species will first accumulate in the low-pressure area LPA, resulting in swelling of the cell side in that area. The swollen cell side or expected vent location (for example, seals close to the tabs, which is mechanically the weakest point on the cell container) will touch the nail part 24A first and realize the venting. The vented gases will go through the hollow tube of the nail part 24A and enter the vent channel 20 and exhaust to outside of the module/pack in a controlled manner. A CO or H2 or CO2 sensor could be located at the outlet of the vent channel for giving a warning signal.

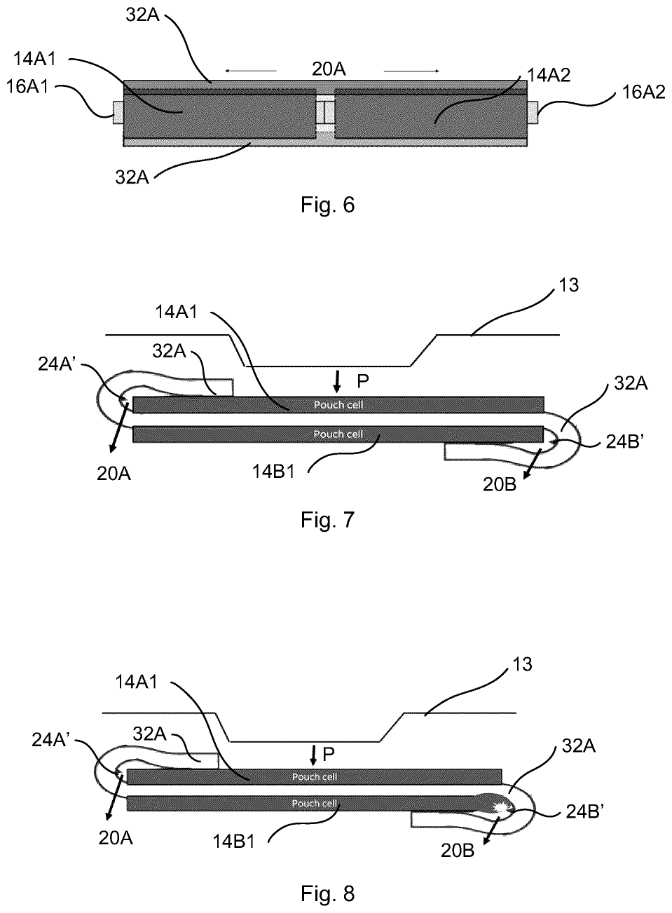

A second embodiment of the electrochemical device 10B will now be described with reference being made to FIGS. 5, 6, 7, and 8, where FIG. 5 shows a perspective view of the electrochemical device comprising a housing in which pouch cells are stacked in a number of stack layers separated by support plates, FIG. 6 shows a view from above of two pouch cells of a first layer of the stack provided on a support plate, a first edge of which is folded over first edges of pouch cells of the first layer, FIG. 7 shows a side view of the first and a second layer of the stack inside the housing, with the first edge of the first support plate being folded over the first edges of the pouch cells of the first layer, with a second edge of the first support plate being folded over second edges of the pouch cells of the second layer and with piercing elements of a second type provided at the folded edges and FIG. 8 shows the same side view as in FIG. 7, where a pouch cell in the second layer experiences thermal runaway and gets pierced by a corresponding piercing element.

There is in this case a pouch cell stack provided in a number of layers. As an example, each layer of the stack comprises two pouch cells that may be electrically interconnected. In FIG. 5 a first and second pouch cell 14A1, 14A2 of a first layer, a second pouch cell 14B1 of a second layer, a first and second pouch cell 14C1, 14C2 of a third layer, a second pouch cell 14D2 of a fourth layer, a first and second pouch cell 14E1, 14E2 of a fifth layer, a second pouch cell 14F2 of a sixth layer, a first and second pouch cell 14G1, 14G2 of a seventh layer and a second pouch cell 14H2 of an eighth layer can be seen. The first pouch cell 14B1 of the second layer can in turn be seen in FIGS. 7 and 8.

Furthermore, there is a number of support plates 32A, 32B, 32C, 32D, between which the layers are stacked. One support plate is in this case provided for two layers of the stack. The pouch cells of a layer may be joined to the support plates through hemming. An edge of a support plate may then be folded over edges of the pouch cells of a layer. As an example, a first support plate 32A is provided between a first layer of pouch cells 14A1, 14A2 and a second layer of pouch cells 14B1, 14B2. A first edge of the first support plate 14A is then folded, along a direction from a first electrical terminal 16A1 of the first pouch cell 14A1 to a first electrical terminal 16A2 of the second pouch cell 14A2, over first edges of the pouch cells 14A1 and 14A2 of the first layer and a second edge of the first support plate 14A is folded around second edges of pouch cells 14B1, 14B2 in the second layer of pouch cells. The first fluid channel 20A, 20B may in this case be provided as a primary first fluid channel 20A between the first support plate 32A and the first edges of the pouch cells 14A1 14A2 of the first stack layer and a secondary first fluid channel 20B between the first support plate 32A and the second edges of the pouch cells 14B1, 14b2 of the second stack layer. The first fluid channels are provided between these overlapping edges and are again provided for transporting of fluid to or from the pouch cell. In this example they are vent channels for transporting gasses from the pouch cells.

Also here there is more than one pouch cell in the electrochemical device and a piercing element for each pouch cell. Furthermore, a first fluid channel passes by each piercing element.

The pouch cells are also provided in at least one stack, where each layer of the stack comprises at least one pouch cell, where in the present example each layer comprises two pouch cells. In this case it is additionally possible that another edge of the support plate is folded over second edges of the pouch cells of a corresponding second stack layer or vice versa

There may also here be a module pack/frame 13 providing pressure P on the stack layers. The module pack/frame 13 may be a part of the holding structure and is also an element applying pressure on the pouch cells for limiting the possible directions of expansion. The different first fluid channels may also be connected to a further vent channel on the pack frame 13 (not shown).

Furthermore, in the area where the first support plate 32A is folded over a pouch cell, the piercing element is also provided. There is thus a first piercing element 24A1′ provided on the first support plate 32A in an area facing the first edge of the first pouch cell 14A1 of the first layer and second piercing element 24B1′ for a first pouch cell 14B1 of the second layer in an area facing the second edge of this cell 14B1.

The safety arrangement in this case comprises the holding structure in the form of support plates, which support plates are equipped with piercing elements being held adjacent corresponding pouch cells with a piercing end facing the corresponding pouch cell. The pressure applied by the module/pack frame 13 limits the number of allowable directions of expansion of the pouch cells. However, they are clearly expandable in a direction towards the corresponding piercing elements.

As can be seen above, the holding structure on which the piercing elements are provided may comprise the support plates 32A, 32B, 32C, 32D that also assist in providing the first fluid channel. However, in this embodiment it is also possible that the module/pack frame 13 is not really a part of the holding structure.

Also, the piercing elements 24A′, 24B′ may be of a second type that does not include a second channel. The piercing elements may thus be pins or nails, for instance shaped as cones.

Like before the thermal runaway, which as an example occurs in the first pouch cell 14B1 of the second layer in FIG. 8, causes the pouch cell 14B1 to expand towards the corresponding piercing element 24B′ so that the piercing element pierces the pouch cell at the piercing end in case of an expansion of the pouch cell along this direction of expansion. Thereby the gas inside the pouch cell is released into the corresponding first fluid channel.

FIG. 5-8 thus show a vent and vent channel design of a pouch battery module/pack, which is based on a hemming structure. One edge of the pouch cell is hemmed on a support plate (materials based on metal, polymer, etc.). Two pouch cells can be attached and hemmed on two sides of the support plate. A nail is located in the hemming structure and faces the pouch cell. At the beginning of thermal runaway, the swelling of the cell will lead to increased cell volume and deform the hemming structure, which reduces the distance between the pouch or bag and the nail. If the thermal runaway continues, the nail will pierce through the pouch or bag and vent gasses will be released from the cell and enter the first fluid channel formed by the hemming structure. Such a first fluid channel therefore plays a role as a vent channel and may guide the vent gas flow to an exhaust.

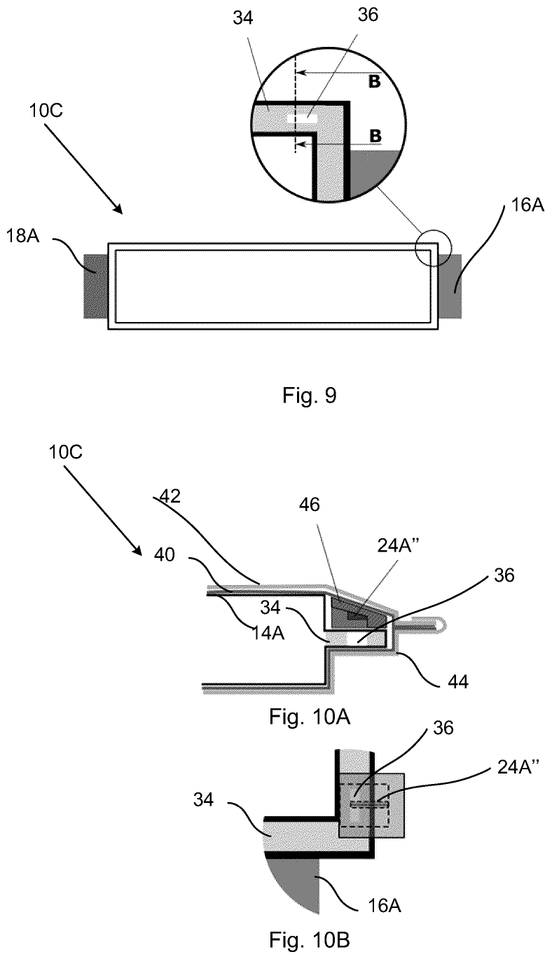

FIGS. 9, 10A, and 10B show an electrochemical device according to a third embodiment, where FIG. 9 shows a view from above of the electrochemical device 10C comprising a pouch cell and without piercing element, where a corner of the electrochemical device is shown in more detail, FIG. 10A shows a cross-sectional view of the corner of the electrochemical device and FIG. 10B shows a view from above of the corner.

In this third embodiment, the pouch cell 14A is provided inside a housing to which the pouch cell is hemmed. There is thus a hemming structure used for fastening the pouch cell to the housing. In this case, the holding structure surrounds the pouch cell 14A and may additionally comprise a first and second piece 42, 44, each having a first edge, where the first edge of the first piece 42 is folded around the first edge of the second piece 44 or vice versa for forming a first mechanical connection. In this example the first edge of the second piece 44 is folded around the first edge of the first piece 42. Moreover, the piercing element is additionally placed between the pouch cell and the holding structure adjacent the mechanical connection.

The first and second pieces may be metallic. Alternatively, they may be ceramic or be made of polymer material.

In this case the piercing element 24A″, which is of a third type, is provided inside the hemming structure used for the pouch cell 14A. There is thus a housing for the pouch cell and this housing has a first and second piece 42, 44, where an edge of the second piece 44 is folded over and edge of the first piece 42 for forming a mechanical connection. The mechanical connection runs at least along a whole long side of the electrochemical device 10C, which long side stretches between first and second electrical terminals 16A, 18A of the pouch cell. The pouch cell 14A is in turn placed inside the housing formed by the two pieces 42, 44.

In an area adjacent the mechanical connection the housing has a shoulder or raised section, which raised section stretches along the previously mentioned long side. There is also a layer of thermal insulation 40 between the pouch cell 14A and the first and the second pieces 42, 44, which thermal insulation 40 is attached to the casing and stretches all the way into the mechanical connection.

The pouch cell also stretches into the raised section. However, it does not completely fill it. As can be seen in FIG. 10A, the pouch cell 14A is more or less aligned with the second piece 44 of the housing in the raised section, but not with the first piece 42. There is a space between the pouch cell 14A and the first piece 42 with thermal insulation 40 in the raised section. In this space there is provided a third type of piercing element 24A″ embedded in polymer, where some of the polymer forms a knife block 46 that is also the holding structure for the piercing element 24A″. Also, the insulation 40 and at least the first piece 42 of the housing may be considered to be a part of the holding structure. The piercing element 24A″ also here has a second fluid channel with a first and a second opening, where the first opening is provided in the knife edge. As can be understood from FIG. 10B, the second opening is in turn provided outside of the housing.

The part of the pouch cell 14A that is provided in the raised section is also filled with thermal insulation 34 or thermosealing material.

However, a cavity or pocket 36 is provided in this thermal insulation 34, which pocket is adjacent and aligned with the piercing element 24A″. It can be seen that a part of the polymer between the piercing element 24A″ and the first piece 42 is used to form a knife block together with parts of the polymer that is aligned with the thermal insulation 34 between the pocket and the mechanical connection.

In this case the electrochemical device only comprises one pouch cell with a safety arrangement comprising a holding structure in the form of the knife support 46 holding a piercing element 24A″ being held adjacent the pouch cell 14A by the holding structure with a piercing end facing the corresponding pouch cell. The pouch cell 14A is also attached to the holding structure through being attached to the knife block.

The pressure applied by the first and second pieces 42, 44 limit the possible directions of expansion of the pouch cell. The only place where the pouch cell 14A can expand is in the raised section and this expansion will be most prominent in the pocket 36. It is thus possible to expand the pouch cell 14A in the pocket in a direction towards the knife edge. Thereby the pouch cell will hit and get pierced by the piercing element 24A″ in case of thermal runaway. The gasses in the pouch cell 14A will thereby also be released through the second fluid channel and possibly into a first fluid channel provided outside of the hemming structure.

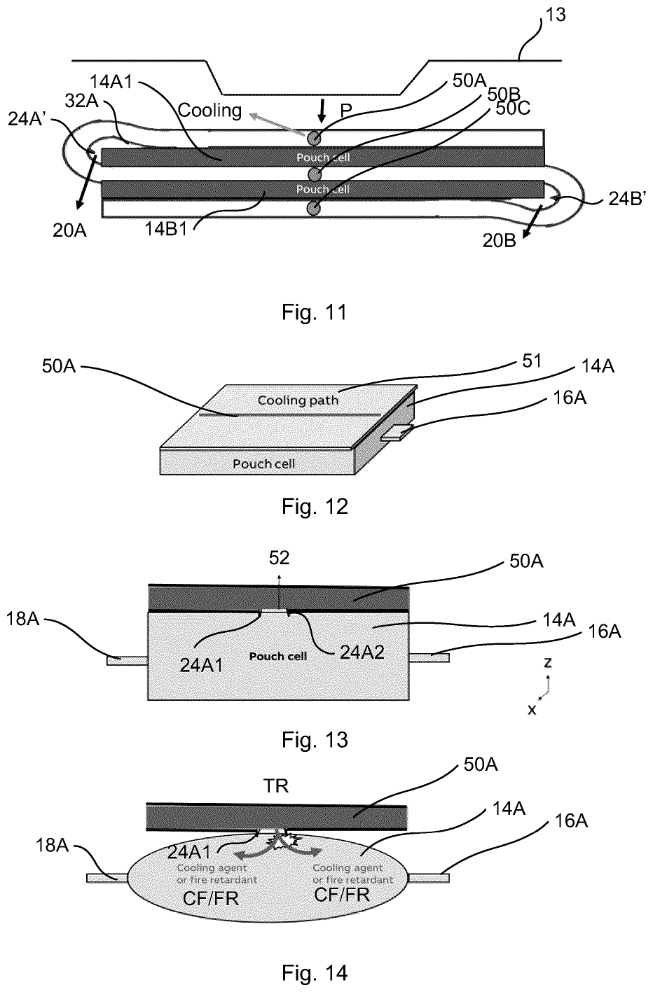

According to a variation of the second embodiment of the electrochemical device, it is possible to combine an air vent with cooling. One example of this is shown in FIG. 11, which shows the same view as FIG. 7. Here there is again a first support plate 32A provided for two layers of pouch cells of the stack. The first support plate 32A may have a meandering structure such that it is provided on the top surface of the pouch cells 14A1 of the first layer, starting from second edges of these pouch cells 14A1 of this first layer, is then folded over first edges of the pouch cells 14A1 of the first layer, passes between the pouch cells 14A1, 14B1 of the first and second layers, is folded around second edges of the pouch cells 14B1 of the second layer and then passes all the way to first edges of the pouch cells 14B1 of the second layer.

The piercing elements 24A′, 24B′, which again are of the second type, and first fluid channels 20A, 20B may be provided in the area where the first support plate 32A is folded around the first edges of the pouch cells 14A1 of the first layer and the area where the first support plate 32A is folded around the second edges of the pouch cells 14B1 of the second layer. Furthermore, cooling channels 50A, 50B, 50C may be provided in the first support plate 32A. There may be a first cooling channel 50A above the first layer of pouch cells, a second cooling channel 50B between the two layers of pouch cells and a third cooling channel 50C below the second layer of pouch cells.

A cooling fluid may here run through the cooling channel in order to cool the support plate, pouch cells and first fluid channels.

Another variation of the use of cooling is shown in FIGS. 12, 13, and 14, where FIG. 12 shows a perspective view of a pouch cell with a cooling plate comprising a cooling channel, FIG. 13 shows a side view of the pouch cell with cooling plate comprising the cooling channel and FIG. 14 shows a side view of the pouch cell with cooling channel, when the pouch cell experiences thermal runaway and gets pierced by a corresponding piercing element that is a variation of the first type.

In this variation a cooling plate 51 is attached to the pouch cell 14A. A first fluid channel 50A that is a cooling channel for a cooling fluid is provided in the cooling plate 51 between the first and second electrical terminals 16A and 18A. The first fluid channel 50A is thus a part of the holding structure. The wall of the cooling channel is provided with a variation of the first type of piercing element 24A1, 24A2 that comprises a second fluid channel. Thereby the cooling plate also forms the holding structure of the piercing element 24A1, 24A2. Moreover, a thermally sensitive film 52 is provided between the pouch cell 14A and the holding structure. In this case the thermally sensitive film 52 is provided in the second fluid channel and prevents fluid flow between the first and second openings of the piercing element. The first fluid channel 50A, the piercing element 24A1, 24A2 and the thermally sensitive film 52 together form an introducing system and triggering mechanism to bring cooling fluid or fire retardants from the first fluid channel 50A into the pouch cell 14A (for example at a center position of the pouch cell) for fire extinguishing purposes.

As can be seen in FIG. 13, the piercing element is provided in the wall of the first fluid channel 50A and having a piercing end with a first opening facing the first pouch cell 14A. Thereby the second opening of the piercing element is also an opening in the wall of the first fluid channel 50A. In this case the piercing element comprises a first and a second pin 24A1, 24A2, separated from each other on a distance defining the first opening and the second fluid channel. The film 52 is thermally sensitive and will be broken at elevated temperatures, for instance at temperatures up to 90° C. Severe pressure build-up inside the pouch cell 14A (volume expansion) could press the pouch or bag towards the sharp edge of the piercing element 24A1, 24A2, triggering to pierce the pouch 14A. The hot vent gas will break the film, and thereby the cooling fluid CF or fire-retardant FR could enter the pouch cell 14A. It can thus be seen that the expanded and hot pouch cell will rupture the thermally sensitive film when expanding along the direction of expansion towards the piercing element.

It can in this case be seen that there is a safety arrangement for one pouch cell 14A where the holding structure is formed by the cooling plate 51 with the first fluid channel 50A and holding the piercing element 24A1, 24A2. The pouch cell 14A is expandable in more than one direction. However, it is also clear that one of these directions in which the pouch cell 14A is expandable is towards the piercing element 24A1, 24A2 that is being held adjacent the pouch cell with the piercing end facing the pouch cell, so that the piercing element pierces the pouch cell at the piercing end in case of an expansion of the pouch cell towards the piercing element.

Although the above-described embodiment is used for introducing cooling fluid and/or fire retardants in the pouch cell 14A, it should be realized that it may just as well be used for venting out gasses in the pouch cell 14A.

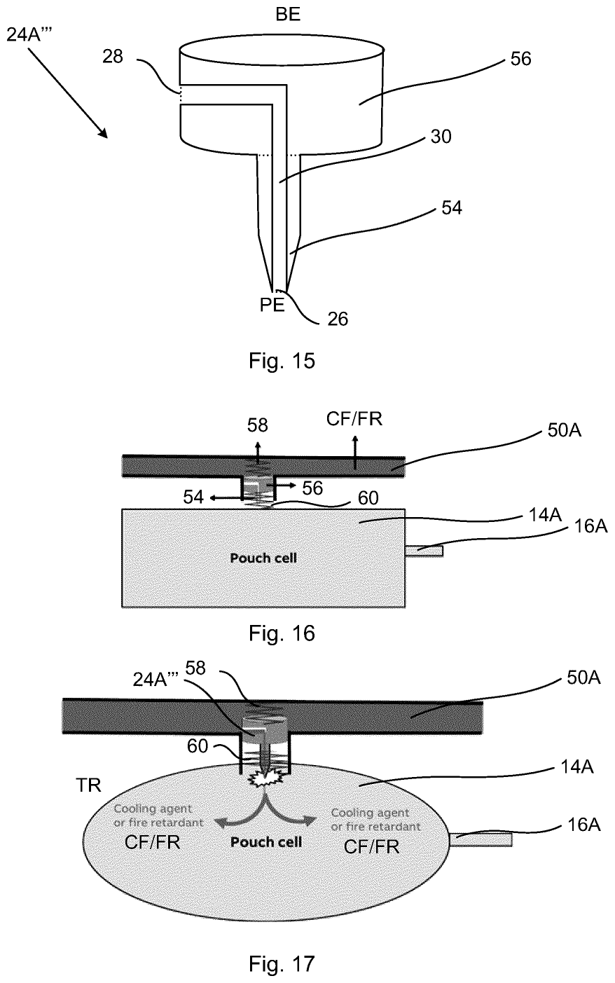

Another variation of the use of cooling is shown in FIGS. 15, 16 and 17, where FIG. 15 schematically shows a side view of a fourth type of piercing element. FIG. 16 shows a side view of the fourth type of piercing element being used together with a pouch cell and a first fluid channel and FIG. 17 shows a side view of the fourth type of piercing element, pouch cell and first fluid channel, when the pouch cell experiences thermal runaway and gets pierced by the piercing element.

In this variation the piercing element 24A′″ comprises a tip 54 joined to a body 56, where the tip comprises the first opening 26 of the second fluid channel 30 at a piercing end PE and the body 56 has a base providing the bottom end BE. The body 56 also comprises the second opening 28. The second fluid channel 30 may in this case be angled so that the second opening 28 is provided in a side of the body 56 between the piercing end PE and the bottom end BE. The body 56 may be shaped as a cylinder having one radius, while the tip 54 may be formed as cylinder with a smaller radius joined to a truncated cone, The first opening 26 may in this case be provided at the tip of the truncated cone, while the second opening is formed in the side of the body cylinder. The first opening 26 is also here provided at the piercing end PE. However, the second opening is not provided at the bottom end BE. Instead, the other end of the piercing element is the side of the body 56.

As can be seen in FIG. 16, the body 56 of the piercing element 24A″′ may be fastened at a first location on an inner wall of the first fluid channel 50A via a first resilient element 58 and the tip 54 of the piercing element 24A″′ may be fastened on the pouch cell via a second resilient element 60, where the inner wall is an inner wall of the first fluid channel 50A that is distanced furthest away from the pouch cell 14A and thereby the first resilient element 58 is placed inside the first fluid channel 50A. Thereby the piercing element 24A″′ is also attached to the holding structure via the first resilient element 58 and the pouch cell 14A is attached to the piercing element 24A″′ via the second resilient element 60. A channel connection is also joined to the first fluid channel 50A, which channel connection is located opposite of the first location. The piercing element 24A″′. is placed in the channel connection leading into the first fluid channel 50A and is movable back and forward in relation to the first location and the pouch cell 14A.

Also in this variation the first fluid channel 50A is part of a cooling plate (not shown) to which the pouch cell is attached. The first fluid channel 50A is in this case also part of a holding structure for the piercing element 24″′, which holding structure may also comprise the cooling plate.

In normal operation the body 56 of the piercing element 24A″′ is wholly located inside the channel connection, which has walls providing sealing of the body 56 and thereby no fluid can pass through the piercing element 24A″′ during normal operation. This is a first position of the piercing element in which the second opening is separated from the first fluid channel.

A cooling plate with the first fluid channel 50A is thus attached to the pouch cell 14A. There is an introducing system to bring cooling fluid CF or fire retardant FR into the pouch cell 14A (for example, the center position) for fire extinguishing. The introducing system contains resilient elements 58, 60, such as springs, and the piercing element 24A″′. The severe pressure build-up inside the pouch cell 14A (volume expansion) could lead to pressed resilient elements, triggering the piercing element to move into a second position in which the second opening is in fluidic contact with the first fluid channel. Thereby the second opening 28 is placed inside the first fluid channel 50A. The movement of the pouch cell 14A also causes the tip 54 of the piercing element 24A′ to pierce the pouch film. Thereby, the expansion of the pouch cell causes the piercing element to move from the first position in the channel connection to the second position in which at least a part of the body 56 comprising the second opening 28 is located inside the first fluid channel 50A. The cooling fluid CF or fire retardant FR could then enter the pouch cell 14A via the second fluid channel 30 in the piercing element 24A′. The expansion of the pouch cell thus causes the piercing element to move in the direction of expansion so that the second opening enters the first fluid channel.

Thereby, it can also in this case be seen that there is a safety arrangement for one pouch cell 14A where the holding structure is formed by the cooling plate (not shown) with the first fluid channel 50A and holding the piercing element 24A1, 24A2. The pouch cell 14A is expandable in more than one direction. However, it is also clear that one of these directions in which the pouch cell 14A is expandable is towards the piercing element 24A″′ that is being held adjacent the pouch cell with the piercing end facing the pouch cell, so that the piercing element pierces the pouch cell at the piercing end in case of an expansion of the pouch cell towards the piercing element.

It should be realized that also this variation could be used for venting of gasses instead.

Unlike the prismatic cell or cylindrical cell, the pouch cell has no safety vent which causes the safety concern for the severe internal pressure build-up during the thermal runaway. Aspects of the present disclosure are directed towards providing a pouch cell with a safety vent.

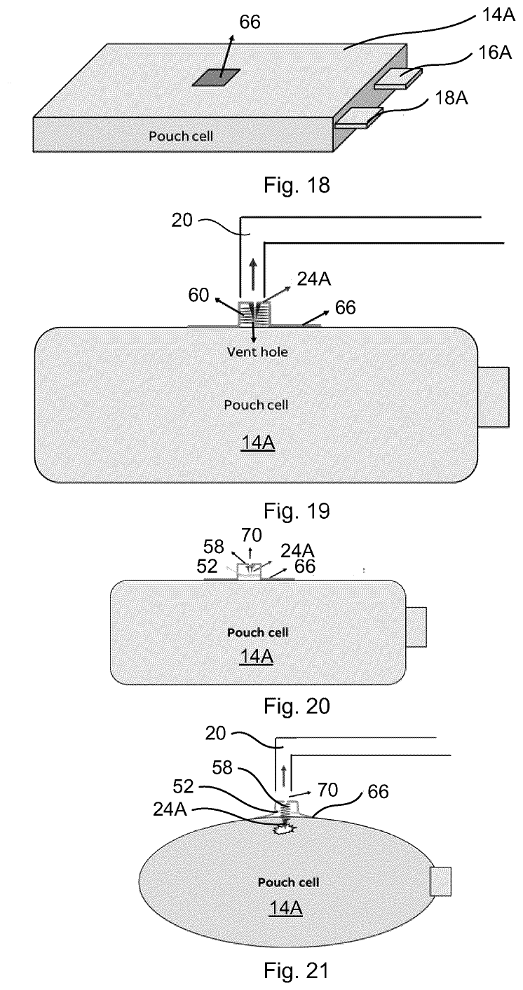

Yet another variation of the electrochemical device where a pouch cell is equipped with a safety vent is shown in FIGS. 18 and 19, where FIG. 18 shows a perspective view of yet another embodiment of the electrochemical device, where a holding structure of the piercing element is provided as a venting tape attached to a pouch cell and FIG. 19 shows a view from above of the pouch cell with venting tape.

In this case the holding structure is thus a tape 66 that is attached or fastened to a pouch cell 14A. As can be seen that tape 66 has a cavity in the bottom of which a piercing element 24A of the first type is provided. The cavity also has a hole in the bottom that faces a first fluid channel 20, which first fluid channel in this case is a vent channel. This hole of the cavity coincides with the second opening of the piercing element 24A. Furthermore, there is also a second resilient element 60 provided between the pouch cell 14A and the piercing element 24A or bottom of the cavity. The pouch cell is thus attached to the piercing element or the holding structure via the second resilient element.

Thereby a safety vent is integrated on a tape which could be sticked to a conventional pouch cell. The position for such vent tape could be in any location on the pouch film (one example is in the center). A piercing element is connected with a resilient element, such as a spring, and a vent cover or tape. There is a second fluid channel in the piercing element allowing the gas or liquid to flow. There is a vent hole on the vent cover or vent tape, in other words, in the bottom of the cavity. The vent cover or vent tape is attached with the pouch cell for mechanical pressure. Under regular conditions, the resilient element 60 is unpressed or partially pressed, avoiding direct contact between the piercing element 24A and the pouch film 14A. Under the abuse conditions and at a first state of thermal runaway, the fast expanded pouch cell could press the resilient element 60 further until reaching the tip of the piercing element 24A. The vent event occurs when the pouch film reaches the piercing element 24 and gets pierced by it. The vented gases will exhaust through the vent channel.

In this case there is thus an electrochemical device comprising a pouch cell and a safety arrangement comprising a holding structure in the form of the safety vent tape comprising a piercing element for and being held adjacent the pouch cell by the holding structure with a piercing end facing the pouch cell. The pouch cell is expandable in several directions. However, it is also clear that one of these directions is towards the piercing element so that it pierces the pouch cell at the piercing end in case of an expansion of the pouch cell along this direction of expansion

FIGS. 20 and 21 show a variation of the vent cover or vent tape 66. FIG. 20 shows a view from above of the pouch cell with venting tape comprising a thermally sensitive film and FIG. 21 shows a view from above of the pouch cell with venting tape comprising a thermally sensitive film between the pouch cell and the holding structure, when the pouch cell experiences thermal runaway and gets pierced by the piercing element.

The holding structure may be a tape fastened to the pouch cell.

In this case the piercing element 24A is joined to the bottom of the cavity via a first resilient element 58, such as a spring. The piercing element 24A is thus attached to the holding structure via the first resilient element 58. There is also a thermally sensitive film 52 between the pouch cell 14A and the holding structure. In this case the film 52 covers the whole piercing element 24A. Thereby, the piercing element 24A is pressed towards the vent hole 70 in the bottom of the cavity by the thermally sensitive film 52. The thermally sensitive film 52 is in this case provided between the piercing end of the piercing element 24A and the pouch cell 14A for being softened by heated emanating from the pouch cell and release the piercing element to move towards the pouch cell.

This embodiment can also be described in the following way. The vent cover or vent tape 66 requires no mechanical pressure on the top of it. The resilient element 58 is attached to the piercing element 24A and partially or completely pressed. There is a film 52 between the piercing element 24A and pouch cell 14A, avoiding the direct contact between the piercing element 24A and pouch cell and maintaining the mechanical pressure from the pressed resilient element 58. When the pouch cell 14A is deformed to certain extent due to the fast internal pressure build-up, the evolved tension on the film 52 results in a weaker mechanical strength and the release of the piercing element 24A. The accelerated piercing element 24A will stab the pouch film and realize the venting function. When the pouch cell 14A is under abuse conditions and at the early stage of thermal runaway, the cell temperature increases dramatically (for example, up to 90° C.). The film 52 is broken due to the high temperature, and the released piercing element 24A will stab the pouch film and realize the venting function. The vent hole 70 at the bottom of the cavity could face to or connect with a vent channel 20, allowing the exhaust of vent gas through the vent channel 20.

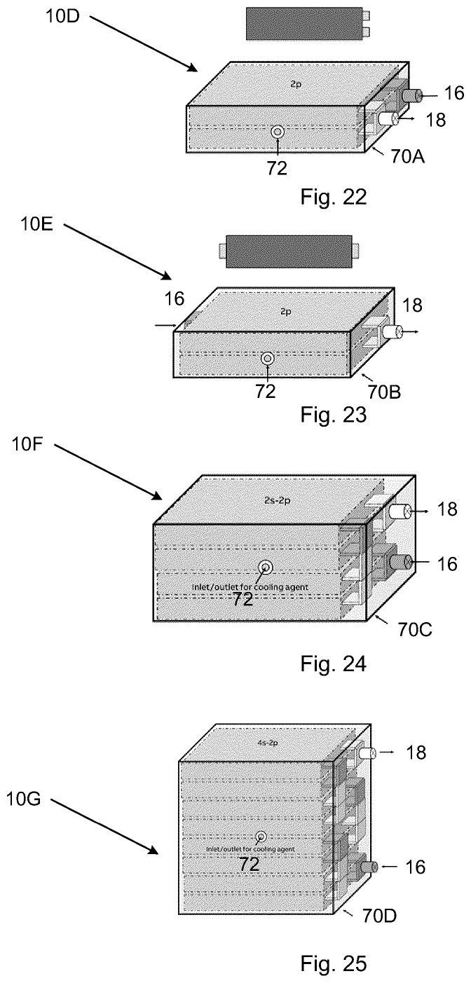

FIGS. 22, 23, 24, 25, and 26 show a hybrid pouch-prismatic cell design combining multiple safety features.

In a further variation of an electrochemical device 10D shown in FIG. 22, there is a housing covering two pouch cells that are connected in parallel with each other. The housing also has an inlet/outlet 72 for cooling and/or vent purposes. The inlet/outlet may connect to a second fluid channel in the interior of the casing, for instance in the form of a cooling channel in a cooling plate provided between the two pouch cells. In this case the first and second electrical connection terminals of the electrochemical device are provided on the same side of the housing.

FIG. 23 shows another variation of an electrochemical device 10E, where is likewise a housing covering two pouch cells that are connected in parallel with each other. The housing also has an inlet/outlet 72 for cooling and/or vent purposes. In this case the first and second electrical connection terminals of the electrochemical device are provided on the opposite sides of the housing.

FIG. 24 shows a variation of the electrochemical device 10F where there is a combination of two pouch cells connected in series and two in parallel inside the housing.

FIG. 25 shows yet another variation of the electrochemical device 10G comprising eight pouch cells, where 4 are connected in series and two in parallel.

The different variations shown in FIG. 22-25 have the following advantages. One, two or more pouch cells could be encapsulated in a case/housing (for example, conventional prismatic cell housing). There is an inlet and outlet on the case/housing for the connection to the cooling tubes. The case/housing is filled with cooling fluids or fire retardants which keep flowing. The pouch cell is immersed in the cooling fluids or fire retardants.

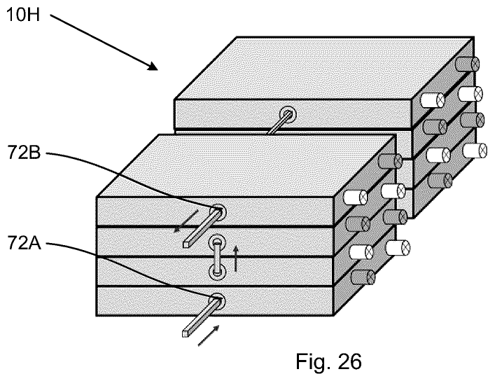

FIG. 26 shows another variation of the electrochemical device 10H. In this case there are a number of housings with two parallel pouch cells as shown in FIG. 22. These housing are provided in two stacks. Furthermore, the inlets and outlets 72 of these housings are interconnected in order to allow a cooling fluid flow through all the housings.

FIG. 26 shows the further integration to large battery pack using hybrid pouch-prismatic battery module/pack with safety features described above.

Considering the growing market of pouch cells, modules, and packs, the present disclosure address the safety issues of pouch cell thermal runaway, and consequent fire accidents. Novel of ways of handling thermal runaway, such as novel vents, vent/fluid channels and embedded fire extinguishing are designed, allowing a safe operation of pouch cells. Therefore, the present disclosure presents diverse safety features to achieve a high safety of pouch cells integrated into modules or packs which low additional effort and at comparatively low cost.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An electrochemical device comprising:
at least one pouch cell; and
a safety arrangement comprising a holding structure and at least one pouch piercing element,
wherein the at least one pouch piercing element is held adjacent to a corresponding pouch cell by the holding structure with a piercing end of the pouch piercing element facing the corresponding pouch cell,
wherein each pouch cell is attached to the holding structure and is expandable in at least one direction, and one of the directions is towards the corresponding piercing element so that the piercing element pierces the pouch cell at the piercing end,
wherein the holding structure comprises at least one element, which is configured to apply pressure on the at least one pouch cell and limit possible directions of expansion,
wherein the holding structure surrounds the pouch cell and comprises a first piece and a second piece, each of the first piece and the second piece has a first edge, and the first edge of the first piece is folded around the first edge of the second piece or vice versa and configured to form a mechanical connection, and
wherein the piercing element is placed between the pouch cell and the holding structure adjacent to the mechanical connection.

2-3. (canceled)

4. The electrochemical device according to claim 1, wherein the pouch cell is surrounded with thermal insulation and wherein the thermal insulation has a cavity adjacent to the piercing element, and the pouch cell can expand from the cavity.

5. The electrochemical device according to claim 1, further comprising a first fluid channel configured to transport fluid to or from the pouch cell.

6. The electrochemical device according to claim 5, wherein the piercing element comprises a second fluid channel stretching between a first opening provided at the piercing end and a second opening at another end of the piercing element, and the second fluid channel allows fluid to flow between exterior and interior of the pouch cell.

7. The electrochemical device according to claim 6, wherein the second opening of the piercing element is an opening in a wall of the first fluid channel.

8. The electrochemical device according to claim 1, wherein the piercing element is attached to the holding structure via a first resilient element.

9. The electrochemical device according to claim 6, wherein the pouch cell is attached to the piercing element or the holding structure via a second resilient element.

10. The electrochemical device according to claim 1, further comprising a thermally sensitive film between the pouch cell and the holding structure.

11. The electrochemical device according to claim 9, wherein:
the piercing element is attached to the holding structure via a first resilient element,
the holding structure comprises the first fluid channel, and the first resilient element is placed between the pouch cell and an interior wall of the first fluid channel furthest away from the pouch cell, and
expansion of the pouch cell causes the piercing element to move from a first position to a second position, and the second opening is separated from the first fluid channel in the first position and opens into the first fluid channel in the second position.

12. The electrochemical device according to claim 7, further comprising a thermally sensitive film between the pouch cell and the holding structure, wherein:
the thermally sensitive film is placed in the second fluid channel of the piercing element so that the pouch cell ruptures the thermally sensitive film when the pouch cell expands along the direction of expansion.

13. The electrochemical device according to claim 1, wherein the holding structure is a tape fastened to the pouch cell.

14. The electrochemical device according to claim 13, further comprising a thermally sensitive film between the pouch cell and the holding structure, wherein:
the piercing element is attached to the holding structure via a first resilient element, and
the thermally sensitive film is provided between the piercing end of the piercing element and the pouch cell, and the thermally sensitive film is softened by heated emanating from the pouch cell so that the piercing element is released to move towards the pouch cell.

15. The electrochemical device according to claim 6, wherein when there is more than one pouch cell, the holding structure comprises a piercing element for each pouch cell and the first fluid channel passes by each piercing element.

16. The electrochemical device according to claim 15, wherein:
the pouch cells are provided in at least one stack,
each layer of the stack comprises at least one pouch cell,
the holding structure comprises a number of support plates, wherein each support plate is provided for two layers of the stack, an edge of the support plate is folded over edges of the pouch cells of a corresponding stack layer or vice versa, and the first fluid channel is provided between these overlapping edges.

17. The electrochemical device according to claim 1, wherein the piercing element comprises a second fluid channel stretching between a first opening provided at the piercing end and a second opening at another end of the piercing element, and the second fluid channel allows fluid to flow between exterior and interior of the pouch cell.

18. The electrochemical device according to claim 17, further comprising a thermally sensitive film between the pouch cell and the holding structure, wherein:
the thermally sensitive film is placed in the second fluid channel of the piercing element so that the pouch cell ruptures the thermally sensitive film when the pouch cell expands along the direction of expansion.

19. The electrochemical device according to claim 7, wherein when there is more than one pouch cell, the holding structure comprises a piercing element for each pouch cell and the first fluid channel passes by each piercing element.

20. The electrochemical device according to claim 19, wherein:
the pouch cells are provided in at least one stack,
each layer of the stack comprises at least one pouch cell, and
the holding structure comprises a number of support plates, wherein each support plate is provided for two layers of the stack, an edge of the support plate is folded over edges of the pouch cells of a corresponding stack layer or vice versa, and the first fluid channel is provided between these overlapping edges.

21. The electrochemical device according to claim 1, wherein the pouch cell is attached to the piercing element or the holding structure via a second resilient element.

22. The electrochemical device according to claim 6, wherein:
the piercing element is attached to the holding structure via a first resilient element,
the holding structure comprises the first fluid channel, and the first resilient element is placed between the pouch cell and an interior wall of the first fluid channel furthest away from the pouch cell, and
expansion of the pouch cell causes the piercing element to move from a first position to a second position, and the second opening is separated from the first fluid channel in the first position and opens into the first fluid channel in the second position.
